(19) United States
(12) Patent Application Publication
(10) Pub. No.: US 2025/0268260 A1
(43) Pub. Date: Aug. 28, 2025

(54) PESTICIDAL COMPOSITIONS INCLUDING AN ISOXAZOLINE COMPOUND

(71) Applicant: SYNGENTA CROP PROTECTION AG, Basel (CH)

(72) Inventors: Stephen Wilson SKILLMAN, Basel (CH); Elke Maria HILLESHEIM, Stein (CH); Sinisa JELOVCAN, Zagreb (HR); Marina PICOLINI, Basel (CH)

(73) Assignee: SYNGENTA CROP PROTECTION AG, Basel (CH)

(21) Appl. No.: 18/858,461

(22) PCT Filed: Apr. 17, 2023
(86) PCT No.: PCT/EP2023/059876

§ 371 Date: Oct. 21, 2024

(30) Foreign Application Priority Data
Apr. 21, 2022 (EP) 22169327.8

(51) Int. Cl. A01N 43/80; A01N 63/23; A01P 7/04

(52) U.S. Cl. CPC A01N 43/80; A01N 63/23; A01P 7/04

(57) ABSTRACT

The present invention relates to a pesticidal composition comprising a component A and a component B, characterized in that the component A is isocycloseram, and the component B is a component selected from Bacillus species, its fermentation solids, and its insecticidal toxins.

The present invention relates to compositions of pesticidally active ingredients and to methods of using the compositions in the field of agriculture.

WO2011067272 discloses that certain isoxazoline compounds have insecticidal activity.

The present invention provides a pesticidal composition comprising a component A and a component B, wherein the component A is isocycloseram, and the component B is a component selected from Bacillus species, its fermentation solids, and its insecticidal toxins.

It has now been found, surprisingly, that the active ingredient composition, or in other words the active ingredient mixture, according to the invention achieves a synergistic effect to especially treat the pests from the Lepidoptera order and/or from the Coleoptera order. The active ingredient composition achieves a high degree of pest control, especially within a very short time.

Throughout this document, the expression “composition” stands for the various mixtures or combinations of components (A) and (B), for example in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the components (A) and (B) is not essential for working the present invention.

Isocycloseram is an insecticidal agrochemical with the following CAS number: 2061933-85-3, and has the following chemical formula:

Isocycloseram can comprise the isomer (5S,4R) which is 4-[(5S)-5-(3,5-dichloro-4-fluoro-phenyl)-5-(trifluoromethyl)-4H-isoxazol-3-yl]-N-[(4R)- 2-ethyl-3-oxo-isoxazolidin-4-yl]-2-methyl-benzamide, and optionally at least one of the isomers selected among isomer (5S,4S), isomer (5R,4R), isomer (5R,4S), and any combinations thereof. In the present invention, the isomer (5S,4S) is 4-[(5S)-5-(3,5-dichloro-4-fluoro-phenyl)-5-(trifluoromethyl)-4H-isoxazol-3-yl]-N-[(4S)- 2-ethyl-3-oxo-isoxazolidin-4-yl]-2-methyl-benzamide; the isomer (5R,4R) is 4-[(5R)-5-(3,5-dichloro-4-fluoro-phenyl)-5-(trifluoromethyl)-4H-isoxazol-3-yl]-N-[(4 R)-2-ethyl-3-oxo-isoxazolidin-4-yl]-2-methyl-benzamide; and the isomer (5R,4S) is 4-[(5R)-5-(3,5-dichloro-4-fluoro-phenyl)-5-(trifluoromethyl)-4H-isoxazol-3-yl]-N-[(4S)- 2-ethyl-3-oxo-isoxazolidin-4-yl]-2-methyl-benzamide. When isocycloseram further comprises at least one of the isomers selected among isomer (5S,4S), isomer (5R,4R), isomer (5R,4S), and any combinations thereof, isocycloseram can comprise a molar proportion of the isomer (5S,4R) greater than 50%, e.g. at least 55%, 60%, 65%, 70%, 75%, 80%, 85%, 90%, 95%, 96%, 97%, 98% or 99%, over the total amount of the isomers (5S,4R), (5S,4S), (5R,4R) and (5R,4S).

The molar proportion of the isomer (5S,4S) can be less than 50%, e.g. at most 30%, 25%, 20%, 15%, 10%, 9%, 8%, 7%, 6%, 5%, 4%, 3%, 2%, 1%, 0.5% or 0.1%, over the total amount of the isomers (5S,4R), (5S,4S), (5R,4R) and (5R,4S).

The molar proportion of the isomer (5R,4R) can be less than 50%, e.g. at most 30%, 25%, 20%, 15%, 10%, 9%, 8%, 7%, 6%, 5%, 4%, 3%, 2%, 1%, 0.5% or 0.1%, over the total amount of the isomers (5S,4R), (5S,4S), (5R,4R) and (5R,4S).

The molar proportion of the isomer (5R,4S) can be less than 50%, e.g. at most 30%, 25%, 20%, 15%, 10%, 9%, 8%, 7%, 6%, 5%, 4%, 3%, 2%, 1%, 0.5% or 0.1%, over the total amount of the isomers (5S,4R), (5S,4S), (5R,4R) and (5R,4S).

The component B is a component selected from Bacillus species.

Bacillus species are insecticidally and/or nematicidally active bacteria, and can include for example Bacillus firmus, Bacillus cereus, Bacillus subtilis, or Bacillus thuringiensis.

The most preferred Bacillus species is Bacillus thuringiensis, and more particularly Bacillus thuringiensis var. kurstaki or Bacillus thuringiensis var. tenebrionis.

For example, the Bacillus thuringiensis of the present invention can be COSTAR supplied by Syngenta, or NOVODOR supplied by Leu+Gygax or BioSciences.

In the present invention, Bacillus compositions of the present invention may be commercially available or may be obtained by culturing the Bacillus strain, e.g. a Bacillus thuringiensis strain, or an insecticidal mutant (strain) derived therefrom according to methods well known in the art. For example, conventional large-scale microbial culture processes include submerged fermentation, solid state fermentation, or liquid surface culture. Towards the end of fermentation, as nutrients are depleted, cells begin the transition from growth phase to sporulation phase, such that the final product of fermentation is largely spores, metabolites and residual fermentation medium. Sporulation is part of the natural life cycle of Bacillus thuringiensis and is generally initiated by the cell in response to nutrient limitation. Fermentation is configured to obtain high levels of colony forming units of and to promote sporulation. The bacterial cells, spores and metabolites in culture media resulting from fermentation may be used directly or concentrated by conventional industrial methods, such as centrifugation, tangential-flow filtration, depth filtration, and evaporation.

The term “fermentation” refers broadly to the enzymatic and anaerobic or aerobic breakdown of organic substances (e.g., a carbon substrate) by microorganisms under controlled conditions (e.g., temperature, oxygen, pH, nutrients, and the like) to produce fermentation products. While fermentation typically describes processes that occur under anaerobic conditions, as used herein it is not intended that the term be solely limited to strict anaerobic conditions, as the term “fermentation” used herein may also occur processes that occur in the presence of oxygen.

Compositions of the present invention include fermentation products. In some embodiments, the concentrated fermentation broth is washed, for example, via a diafiltration process, to remove residual fermentation broth and metabolites. The term “broth concentrate,” as used herein, refers to whole broth (fermentation broth) that has been concentrated by conventional industrial methods, as described above, but remains in liquid form. The term “fermentation solid,” as used herein, refers to the solid material that remains after the fermentation broth is dried. The term “fermentation product,” as used herein, refers to whole broth, broth concentrate and/or fermentation solids. Compositions of the present invention include fermentation products.

Fermentation products produced from Bacillus thuringiensis species will in typical embodiments also include insecticidal toxins, e.g. at least one of a crystal (Cry) protein, a cytolytic (Cyt) protein, and a vegetative insecticidal protein (Vip). For example, Bacillus thuringiensis subsp. kurstaki strain SA-12 contains genes encoding for potential production of cytotoxin type K2 (CytK2), six crystal insecticidal proteins (Cry1Aa, Cry1Ab, Cry1Ac, Cry1Ia, Cry2Aa, Cry2Ab), two Cry-like proteins and one vegetative insecticidal protein (VIP 3Aa10).

The fermentation broth or broth concentrate can be dried with or without the addition of carriers using conventional drying processes or methods such as spray drying, freeze drying, tray drying, fluidized-bed drying, drum drying, or evaporation.

The resulting dry products may be further processed, such as by milling or granulation, to achieve a specific particle size or physical format. Carriers may also be added post-drying.

Cell-free preparations of fermentation broth of the strains of the present invention can be obtained by any means known in the art, such as extraction, centrifugation and/or filtration of fermentation broth. Those of skill in the art will appreciate that so-called cell-free preparations may not be devoid of cells but rather are largely cell-free or essentially cell-free, depending on the technique used (e.g., speed of centrifugation) to remove the cells. The resulting cell-free preparation may be dried and/or formulated with components that aid in its application to plants or to plant growth media. Concentration methods and drying techniques described above for fermentation broth are also applicable to cell-free preparations.

In one embodiment, the fermentation product comprises at least about 1×10⁴ colony forming units (CFU) of the microorganism (e.g., a Bacillus thuringiensis strain) or an insecticidal mutant strain thereof)/mL broth. In another embodiment, the fermentation product comprises at least about 1×10⁵ colony forming units (CFU) of the microorganism/mL broth. In another embodiment, the fermentation product comprises at least about 1×10⁶ CFU of the microorganism/mL broth. In yet another embodiment, the fermentation product comprises at least about 1×10⁷ CFU of the microorganism/mL broth. In another embodiment, the fermentation product comprises at least about 1×10⁸ CFU of the microorganism/mL broth. In another embodiment, the fermentation product comprises at least about 1×10⁹ CFU of the microorganism/mL broth. In another embodiment, the fermentation product comprises at least about 1×10¹⁹ CFU of the microorganism/mL broth. In another embodiment, the fermentation product comprises at least about 1×10¹¹ CFU of the microorganism/mL broth.

“Mutant” refers to a bacterial species that has an alteration or variation (for example, in the nucleotide sequence or the amino acid sequence), which causes said organism and/or sequence to be different from the naturally occurring or wild-type organism with which the mutant is being compared. In some embodiments, this alteration or variation can be one or more nucleotide and/or amino acid substitutions or modifications (e.g., deletion or addition). In some embodiments, the one or more amino acid substitutions or modifications can be conservative; here, such a conservative amino acid substitution and/or modification in a “mutant” does not substantially diminish the activity of the mutant in relation to its non-mutant form. In some examples the mutation may be to make the Bacillus species auxotrophic for example.

According to the present invention, the components (A) and (B) are present in a synergistically effective amount in the composition.

More particularly, the weight ratio in grams of active ingredients of component A to component B in the composition can range from 1:2000 to 1:2, preferably from 1:1000 to 1:10, preferably from 1:1000 to 1:100, preferably from 1:400 to 1:100, and more preferably from 1:200 to 1:100.

The component A according to the present invention can be used to prepare a suspension concentrate (SC), a flowable suspension (FS), a suspoemulsion (SE), a suspension concentrate-capsule suspension blend (ZC), water soluble granules (SG), water dispersible granules (WG), water dispersible tablets (WT), a dispersible concentrate (DC), or an oil dispersion (OD). The most preferred formulation type is a suspension concentrate, a flowable suspension or a dispersible concentrate.

The above-mentioned formulations can be prepared in using ingredients and techniques well-known in the art.

For example, the pesticidal composition according to the present invention, especially for the preparation of the component A, can further comprise at least one of the components selected among a polyoxyalkylene copolymer, an acrylic graft copolymer, an oxygenated hydrocarbon, a lignin compound, a lactamide compound, and an ether type solvent, preferably at least two of said components, preferably at least three of said components, and more preferably at least four of said components.

In a particular embodiment to form a suspension concentrate, the pesticidal composition, especially for the preparation of the component A, can further comprise at least one of the components selected among a polyoxyalkylene copolymer, an acrylic graft copolymer, and an oxygenated hydrocarbon, preferably at least two of said components, and more preferably said three components.

In a particular embodiment to form a dispersible concentrate, the pesticidal composition, especially for the preparation of the component A, can further comprise at least one of the components selected among an acrylic graft copolymer, a lignin compound, a lactamide compound, and ether type solvent, preferably at least two of said components, preferably at least three of said components, and more preferably said four components.

In the present invention, the polyoxyalkylene copolymer can be obtained from at least two different alkylene oxides, such as from ethylene oxide and propylene oxide monomers.

The polyoxyalkylene copolymer can be more preferably a polyoxyalkylene block copolymer of the AB, ABA, BAB, or ABABA type.

More particularly, the polyoxyalkylene copolymer can be prepared by ring-opening polymerization of the corresponding cyclic ethylene oxide and propylene oxide monomers.

Typically, the ring-opening polymerization is initiated by addition of water and alkali hydroxides, such as sodium hydroxide and potassium hydroxide. The block structure of the copolymer is formed by first polymerizing a polymer block using one monomer, before adding a second monomer to form further polymer blocks.

In a preferred embodiment, the polyoxyalkylene copolymer can be an ethylene oxide-propylene oxide-ethylene oxide block copolymer (EO-PO-EO block copolymer), or in other words a poly(ethylene oxide)-poly(propylene oxide)-poly(ethylene oxide) block copolymer or a poly(ethylene glycol)-poly(propylene glycol)-poly(ethylene glycol) block copolymer.

The polyoxyalkylene copolymer of the invention, and more particularly the EO-PO-EO block copolymer, can have a molecular weight from 1,000 to 15,000 g/mol, and more preferably from 3,000 to 7,000 g/mol.

In the present invention, the expression “a molecular weight” means an average molecular weight (i.e. a molecular weight approximately of). Molecular weight of a polymer, or in other words the molar mass, can be easily determined by method well-known in the art, such as gel permeation chromatography (GPC).

In a first embodiment, the EO-PO-EO block copolymer can have a polypropylene oxide molecular weight from 900 to 4,000 g/mol, and preferably from 2,000 to 4,000 g/mol. In other words, the polypropylene oxide molecular weight is the molecular weight of the poly(propylene oxide) block of the EO-PO-EO block copolymer.

In a second embodiment, the EO-PO-EO block copolymer can have an ethylene oxide content from 10 to 80%, and preferably from 30 to 50%, over the total weight of the copolymer. In other words, the ethylene oxide content is the percentage of the poly(ethylene oxide) block in the EO-PO-EO block copolymer.

In a third embodiment, the EO-PO-EO block copolymer can have the features of the first embodiment and the features of the second embodiment.

Examples include the GENAPOL® PF series (CLARIANT), the PLURONIC® series (BASF), the SYNPERONIC® PE series (CRODA), or the TOXIMUL® series (STEPAN).

The acrylic graft copolymer has typically a comb-or star-like structure, and preferably a comb-like structure.

Graft copolymers are branched copolymers wherein the components forming the side chains are structurally different from the components forming the main chain.

Comb-like polymers comprise of a main chain (backbone) which contains branch points from each of which a linear side chain emanates.

Star-like polymers comprise of a multifunctional centre from which at least three polymer chains radiate.

In a preferred embodiment, the acrylic graft copolymer can be an amphipathic copolymer.

More particularly, the acrylic graft copolymer comprises at least one component A, which is solvated by an aqueous medium (hydrophilic part), and at least one other component B which is hydrophobic.

Suitable acrylic graft copolymers may comprise polyethylene glycol, mono-methyl ethers of polyethylene glycol, poly(vinyl pyrrolidone), poly(acrylamide) or poly(vinyl alcohol) as hydrophilic side chain, while the hydrophobic backbone may comprise polymers and copolymers of styrene, methyl acrylate, methyl methacrylate, ethyl acrylate, 2-ethylhexyl acrylate, lauryl methacrylate, or vinyl acetate.

Such acrylic graft copolymers can for example be prepared by converting the monomethyl ether of a polyethylene glycol to the acrylic or methacrylic ester, which is then subjected to radical polymerization with other unsaturated monomers such as styrene, ethyl acrylate, or methyl methacrylate. It is also possible to prepare such acrylic graft copolymers by reacting a hydrophobic polymer backbone, which consists chemically reactive sites such as carboxyl, hydroxy, or amine groups, with monomeric alkylene oxides, such as ethylene oxide and propylene oxide, to form hydrophilic side chains.

More preferably, the acrylic graft copolymer is a non-ionic polymer, and more particularly with a comb-like structure.

In the present invention, the acrylic graft copolymer can comprise polyethylene glycol and/or mono-ether polyethylene glycol side chains.

The acrylic graft copolymer can also comprise a backbone obtained from acrylate and/or methacrylate monomers.

Even more preferably, the acrylic graft copolymer can comprise a backbone obtained from acrylate and/or methacrylate monomers, and side chains comprising polyethylene glycol and/or mono-ether polyethylene glycol, giving more particularly the polymer a comb-like structure.

For example, the acrylic graft copolymer of the present invention can be Atlox 4913™ supplied by CRODA, or Tersperse 2500™ supplied by HUNTSMAN.

The oxygenated hydrocarbon compound can be selected among alkyl ether compounds, alkyl ester compounds, and any mixture thereof; and preferably among polyethylene glycol alkyl ether, sulfonated alkyl ester compounds, and any mixture thereof. In other words, the oxygenated hydrocarbon compound is preferably different from the polyoxyalkylene copolymer and from the acrylic graft copolymer.

The polyethylene glycol alkyl ether can be obtained by reacting alcohols with ethylene oxide. Suitable alcohols are linear or branched aliphatic alcohols with a chain length from C₂ to C₁₅, preferably with a chain length from C₇ to C₁₁, and more preferably with a chain length of C₉ or C₁₀. An example can be Rhodasurf DA/630-E™ supplied by SOLVAY-RHODIA,

The sulfonated alkyl ester compound can be a sulfosuccinate ester or a salt of a sulfosuccinate ester. An example can be Aerosol™ OT-B, supplied by SOLVAY-RHODIA.

The lignin compound can have a molecular weight up to 10000 g/mol, and preferably up to 5000 g/mol. In a preferred embodiment, the lignin compound can have a molecular weight of at least 1000 g/mol.

The lignin compound can be more particularly a kraft lignin and/or an unsulfonated lignin. In a preferred embodiment, the lignin compound can be an unsulfonated kraft lignin.

An unsulfonated kraft lignin can be defined as a lignin separated from cellulose using the Kraft process (also known as sulfate process), namely separation using sodium hydroxide (NaOH) and sodium sulfide (Na2S). The use of this process gives rise to unsulfonated lignins, unlike those produced via an acidic sulfite process.

The lactamide compound can be of formula I: CH₃CH(OH)C(=O)NR₁R₂ (I), wherein R₁ and R₂ are each independently hydrogen; or C₁₋₆alkyl, C₂₋₆alkenyl or C₃₋₆cycloalkyl, each of which is optionally substituted by up to three substituents independently selected from phenyl, hydroxy, C₁₋₅alkoxy, morpholinyl and NR₃R₄ where R₃ and R₄ are each independently C₁₋₃alkyl; or phenyl optionally substituted by up to three substituents independently selected from C₁₋₃alkyl; or R₁ and R₂ together with the nitrogen atom to which they are attached form a morpholinyl, pyrrolidinyl, piperidinyl or azepanyl ring, each of which is optionally substituted by up to three substituents independently selected from C₁₋₃alkyl. In a preferred embodiment, R₁ and R₂ of the lactamide compound of formula I can be each independently hydrogen or C₁₋₆alkyl, and more preferably hydrogen or C₁₋₃alkyl such as lactic acid dimethyl amide or lactic acid diethyl amide.

The ether type solvent can be selected among dialkyl ethers, dialkyl amide ethers, glycol ethers, aliphatic ethers, and cyclic ethers. For example, the ether type solvent can be methyl-5-(dimethylamino)-2-methyl-5-oxopentanoate, diethylene glycol monomethyl ether, diethylene glycol monoethyl ether, diethylene glycol monobutyl ether, diethylene glycol monophenyl ether, tetrahydrofuran or dibutyl ether.

In the present invention, the composition may further comprise water.

The composition of the present invention may further comprise one or more formulation additives well-known in the art. In particular, the formulation additives can be selected among an anti-freeze agent, an anti-foam agent, an anti-bacterial agent (or biocide), a viscosity modifier (or thickener), a pH modifier, and any mixture thereof.

In a preferred embodiment, the composition of the present invention can further comprise at least a silicone compound as anti-foam agent. Examples of silicone compounds can be polydimethylsiloxane.

Other suitable formulation additives include amongst others known to the person skilled in the art, antioxidant, emulsifying agent, colourant (or pigment), perfume, adjuvant, attractant, binder, buffer, solid support (carrier), coating agent, deodorant, emetic agent, inorganic filler, safener, organic solvent, photo-protecting agent, and any mixture thereof.

The composition of the present invention may further comprise an additional agrochemical. The additional agrochemical can be an insecticide, a fungicide, an herbicide, a synergist, a plant growth regulator, a nematicide, a plant nutrient, a plant fertilizer, and a mixture thereof.

The composition of the present invention may comprise a suitable amount of one or several of the above-mentioned ingredient(s) to obtain the respective properties, when appropriate.

In a particular embodiment when the component A is prepared to form a formulation, such as a suspension concentrate, a flowable suspension, a suspoemulsion, a suspension concentrate-capsule suspension blend, water soluble granules, water dispersible granules, water dispersible tablets, a dispersible concentrate, or an oil dispersion, the formulation may comprise:
from 0.01% to 50.0% by weight of component A, and preferably from 0.1% to 40.0% by weight of component A, over the total weight of the formulation,
a polyoxyalkylene copolymer, preferably from 0.0005% to 50.0% by weight of polyoxyalkylene copolymer, and more preferably from 0.002% to 25.0% by weight of polyoxyalkylene copolymer, over the total weight of the formulation,
an acrylic graft copolymer, preferably from 0.0005% to 20.0% by weight of the acrylic graft polymer and more preferably from 0.001% to 10.0% by weight of the acrylic graft polymer, over the total weight of the formulation,
an oxygenated hydrocarbon compound, preferably from 0.0001% to 10.0% by weight of the oxygenated hydrocarbon compound, and more preferably from 0.001% to 5.0% by weight of the oxygenated hydrocarbon compound, over the total weight of the formulation, and
optionally water.

The above formulation is preferred to form a suspension concentrate or a flowable suspension.

In a particular embodiment when the component A is prepared to form a formulation, such as a suspension concentrate, a flowable suspension, a suspoemulsion, a suspension concentrate-capsule suspension blend, water soluble granules, water dispersible granules, water dispersible tablets, a dispersible concentrate, or an oil dispersion, the formulation may comprise:
(a) from 0.01% to 70.0% by weight of component A, and preferably from 0.1% to 50.0% by weight of component A, over the total weight of the formulation,
(b) a lignin compound, preferably from 0.01% to 30.0% by weight of the lignin compound, and preferably 0.1% to 20.0% by weight of the lignin compound, over the total weight of the formulation,
(c) optionally acrylic graft copolymer, preferably from 0.01% to 30.0% by weight of the acrylic graft copolymer, and preferably from 0.1% to 20.0% by weight of the acrylic graft copolymer, over the total weight of the formulation,
(d) optionally a lactamide compound, preferably from 10.0% to 90.0% by weight of the lactamide compound, and preferably from 20% to 80% by weight of the lactamide compound, over the total weight of the composition, and
(e) optionally an ether type solvent, preferably from 1.0% to 70.0% by weight of the ether type solvent, and preferably from 1.0% to 60.0% by weight of the ether type solvent, over the total weight of the composition.

The above formulation is preferred to form a dispersible concentrate.

In said particular embodiment, the isocycloseram, the polyoxyalkylene copolymer, the acrylic graft copolymer and the oxygenated hydrocarbon are the compounds described in the present description.

The component B according to the present invention can be used to prepare water dispersible granules (WG) or wettable powders (WP).

The above-mentioned formulations can be prepared in using ingredients and techniques well-known in the art.

For example, water dispersible granules including the component B can be the product COSTAR® WG supplied by Syngenta.

The pesticidal composition according to the present invention, especially for the preparation of the component B, can further comprise at least a sulfonated compound, preferably a polyorganosulfonate salt, and more preferably sodium poly(naphthaleneformaldehyde) sulfonate.

In a particular embodiment when the component B is prepared to form a formulation, such as water dispersible granules or wettable powders, the formulation may comprise:
from 1.0% to 40% by weight of component B, and preferably from 10% to 30% by weight of component B, over the total weight of the formulation, and
from 20 to 60% by weight of sulfonated compound over the total weight of the formulation.

In a preferred embodiment according to the present invention, the pesticidal composition can be a mixture of the component A and the component B, and more particularly a mixture of:
a formulation containing the component A, such as a suspension concentrate, a flowable suspension, a suspoemulsion, a suspension concentrate-capsule suspension blend, water soluble granules, water dispersible granules, water dispersible tablets, a dispersible concentrate, or an oil dispersion, and
a formulation containing the component B, such as water dispersible granules or wettable powders.

Said mixture can be diluted with water in a tank mix.

The formulation containing the component A and the formulation containing the component B can be added to a farmer's spray tank of water or it may be applied, once mixed, directly without further dilution.

In a further embodiment, the component A and the component B can respectively be applied in any desired sequence or simultaneously.

In a further embodiment, the formulation containing the component A and the formulation containing the component B can respectively be applied in any desired sequence or simultaneously.

Another object of the present invention relates to a method of combating and/or controlling an animal pest, which comprises applying to a pest, to a locus of a pest, to a plant susceptible to attack by a pest, or to a plant propagation material susceptible to attack by a pest, a combination of components A and B, characterized in that the components A and B are as defined in the present invention.

In other words, said combination is a pesticidal combination comprising a component A and a component B as defined in the present invention, wherein the component A is isocycloseram, and the component B is a component selected from Bacillus species, its fermentation solids, and its insecticidal toxins. Said combination can be applied in any desired sequence or simultaneously.

The combination of components A and B can be the pesticidal composition according to the present invention.

In the method according to the present invention, the composition can be generally applied with an effective amount of isocycloseram and with an effective amount of Bacillus species. More particularly, the weight ratio of component A to component B in the composition can range from 1:1 to 1:10000, preferably from 1:1 to 1:2000, preferably from 1:1 to 1:1000, preferably from 1:1 to 1:500, preferably from 1:1 to 1:400, preferably from 1:1 to 1:300, more preferably from 1:1 to 1:200, more preferably from 1:1 to 1:100, more preferably from 1:1 to 1:10, and more preferably from 1:2 to 1:10

More particularty, for foliar application, the weight ratio of component A to component B in the composition can range from 1:100 to 1:120, and preferably from 1:110 to 1:115, such as for example 1:112.5.

For seed treatment application, the weight ratio of component A to component B in the composition can range from 1:2 to 1:20, preferably from 1:3 to 1:10, and more preferably from 1:5 to 1:10.

Said composition can be a mixture of a formulated component A as described in the present invention (i.e. a formulation containing the component A) and a formulated component B as described in the present invention (i.e. a formulation containing the component B). Water can be optionally added into the mixture.

The animal pest can be an invertebrate animal pest, such as insects and acarines. The pest can be more preferably selected from the Lepidoptera order and from the Coleoptera order.

The Lepidoptera order can be from the Noctuidae family (such as for example Spodoptera sp., Helicoverpa sp., Trichoplusia sp., Chrysodeixis sp., Autographa sp.) and the Gelechiidae family (such as for example Tuta sp., Anarsia sp., Phthorimaeasp.). The most preferred pest can be from the Spodoptera genus, such as for example Spodoptera littoralis, from the Tuta genus, such as for example Tuta absoluta, or from the Helicoverpa genus, such as for example Helicoverpa armigera.

The Coleoptera order can be selected from Elateridae family (such as for example Agriotes spp., Ludius spp., Ctenicera spp., Selatosomus spp., Chyptohypnus spp., Hypnoidus spp., Limonius spp., Aeolus spp., Hadromorphus spp., Hypnoidus spp., Melanotus spp., Pheletes spp., Conoderus spp., Athous spp., Agrypnus spp., Agrypnus variabilis, Pheletes californicus, Ludius aeripennis tinctus, Ludius aeripennis destructor, Ctenicera destructor, Ctenicera aeripennis destructor, Selatosomus destructor, Selatosomus aeripennis destructor, Selatosomus aeripennis aeripennis, Chyptohypnus nocturnus bicolor, Cryptohypnus nocturnus (Eschscholtz), Hypnoidus nocturnus, Hypolithus bicolor, Limonius californicus, Aeolus mellillus, Agriotes mancus, Hadromorphus glaucus, Agriotes brevis, Agriotes rufipalpis, Agriotes proximus, Agriotes littigiosus, Agriotes criddlei, Agriotes lineatus, Agriotes obscurus, Agriotes sputator, Agriotes, sordidus, Agriotes ustulatus, Hypnoidus abbreviates, Limonius canus, Limonius pectoralis, Limonius infuscatus, Agriotes fuscicollis, Melanotus opacaicicollis leconte), Tenebrionidae family (such as for example Gonocephalum spp., Adelium spp., Pterohelaeus spp., Gonocephalum aequatoriale, G. bilineatum, G. carpentariae (northern false wireworm), G. contractum, G. depressum, G. dorsogranosum, G. elderi (vegetable beetle), G. hoffmannseggii, G. macleaya, G. misellum, G. patruele, G. pusillum, G. reticulatum, G. rusticum, G. seriatum, G. setulosum, G. simplex (dusty surface beetle), G. torridum, G. tuberculatum, G. walker, Adelium brevicorne, Pterohelaeus alternatus) Chrysomelidae family (such as for example Diabrotica spp., Leptinotarsa spp., Phyllotreta spp., Chaetocnema spp.), Scarabidae family (such as for example Phyllophaga spp., Cyclocephala spp., Popilia spp., Halotrichia spp.), Curculionidae family (such as for example Anthonomus spp., Sphenopherus spp., Otiorhynchus spp.), and Nitidulidae family (such as for example Meligethes spp.). The most preferred pest can be from the Diabrotica genus, such as for example Diabrotica balteata, or from the Agriotes genus, such as for example Agriotes lineatus.

The composition according to the present invention can be used for combating and/or controlling (i.e. containing or destroying) pests of the abovementioned type which occur in particular on plants, especially on useful plants and ornamentals in agriculture, in horticulture and in forests, or on organs, such as fruits, flowers, foliage, stalks, tubers or roots, of such plants, and in some cases even plant organs which are formed at a later point in time remain protected against these pests. Said composition can also be used for combating and/or controlling (i.e. containing or destroying) pests of the abovementioned type which occur in particular in soil and/or on plant propagation material.

The term “plant” as used in the present description includes seedlings, bushes and trees. Suitable target crops are, in particular, cereals, such as wheat, barley, rye, oats, rice, maize (e.g. field corn, popcorn, corn), millet or sorghum; beet, such as sugar or fodder beet; fruit, for example pomaceous fruit, stone fruit or soft fruit, such as apples, pears, plums, peaches, almonds, cherries or berries, for example strawberries, raspberries or blackberries; leguminous crops, such as beans, lentils, peas or soya (soya beans); oil crops, such as oilseed rape, mustard, poppies, olives, sunflowers, coconut, castor, cocoa or ground nuts; cucurbits, such as pumpkins, cucumbers, melons, watermelons or squashes; fibre plants, such as cotton, flax, hemp or jute; citrus fruit, such as oranges, lemons, grapefruit or tangerines; vegetables, such as spinach, lettuce, asparagus, cabbages, broccolis, cauliflowers, carrots, onions, tomatoes, potatoes, eggplants, peppers or bell peppers; Lauraceae, such as avocado, Cinnamonium or camphor; and also tobacco, nuts, coffee, sugarcane, tea, grapevines, hops, the plantain family and latex plant.

In a preferred embodiment, the plant can be selected from:
cereals, such as wheat, barley, rye, oats, rice, maize (e.g. field corn, popcorn, corn), millet or sorghum;
leguminous crops, such as beans, lentils, peas or soya (soya beans);
fibre plants, such as cotton, flax, hemp or jute; and
vegetables, such as spinach, lettuce, asparagus, cabbages, broccolis, cauliflowers, carrots, onions, tomatoes, potatoes, peppers or bell peppers.

The term “plant propagation material” is understood to denote all the generative parts of the plant, such as seeds, which can be used for the multiplication of the latter including vegetative plant material such as cuttings. There may be mentioned, as plant propagation material, seeds (in the strict sense), roots, fruits, tubers, bulbs, rhizomes, parts of plants. The plant propagation material can be treated with the composition of the invention before the material is sown or planted. Alternatively, the plant propagation material may be treated with the composition of the invention during sowing or planting. Additionally, the composition of the invention may be applied to the previously treated propagation material before or during its planting. The composition of the invention may be applied during the sowing of the seed. The composition may also be used to plant propagation material derived from plants grown in a green house and/or during transplantation.

More preferably the plant propagation material is plant seeds. The seed treatment can occur to an unsown seed, and the term “unsown seed” is meant to include seed at any period between the harvest of the seed and the sowing of the seed in the ground for the purpose of germination and growth of the plant. Treatment to an unsown seed is not meant to include those practices in which the composition is applied to the soil but would include any application practice that would target the seed during the sowing/planting process. The treated plant propagation material of the present invention can be treated in the same manner as conventional plant propagation material. The treated propagation material can be stored, handled, sown and tilled in the same manner as any other pesticide treated material.

In a first particular embodiment, the pesticidal composition according to the present invention can be applied to a pest, to a locus of a pest, or to a plant susceptible to attack by a pest, in spraying the pesticidal composition, for example dispensed from a spray container for foliar application. Said method can involve an effective amount of the pesticidal composition applied at a rate of:
from 0.01 g to 200 g of the component A per hectare, preferably from 0.1 g to 100 g of the component A per hectare, and more preferably from 50 to 100 g of the component A per hectare; and
from 0.1 g to 1000 g of the component B per hectare, preferably from 1 g to 500 g of the component B per hectare, and more preferably from 100 g to 500 g of the component B per hectare.

More particularly for foliar application, the weight rate of the component B is at least 10 times higher than the weight rate of the component A, preferably at least 50 times higher than the weight rate of the component A, and more preferably at least 100 times higher than the weight rate of the component A. Preferably, the weight rate of the component B is at most 200 times higher than the weight rate of the component A.In a second particular embodiment, the pesticidal composition according to the present invention can be applied to a plant propagation material susceptible to attack by a pest. In this case, the pesticidal composition can be used as seed treatment. Said method can involve an effective amount of the pesticidal composition applied at a rate of:
from 0.01 g to 30 g of the component A per 100 kg of seeds, preferably from 0.01 g to 25 g of the component A per 100 kg of seeds, preferably from 0.1 g to 25 g of the component A per 100 kg of seeds, preferably from 0.1 g to 10 g of the component A per 100 kg of seeds, preferably from 0.1 g to 5 g of the component A per 100 kg of seeds, and more preferably from 0.5 g to 1 g of the component A per 100 kg of seeds, and
from 1 g to 1000 g of the component B per 100 kg of seeds, preferably from 5 g to 500 g of the component B per 100 kg of seeds, preferably from 10 g to 200 g of the component B per 100 kg of seeds, preferably from 10 g to 150 g of the component B per 100 kg of seeds, and more preferably from 50 g to 100 g of the component B per 100 kg of seeds.

More particularly for seed treatment application, the weight rate of the component B is at least 2 times higher than the weight rate of the component A, preferably at least 2.5 times higher than the weight rate of the component A, preferably at least 3 times higher than the weight rate of the component A, more preferably 5 times higher than the weight rate of the component A,
and more preferably 10 times higher than the weight rate of the component A. The weight rate of the component B can be at most 50 times higher than the weight rate of the component A, preferably at most 40 times higher than the weight rate of the component A, and more preferably at most 30 times higher than the weight rate of the component A.

In another object, the pesticidal composition of the present invention can be used to combat and/or control the pests:
from the Lepidoptera order, more preferably from the Noctuidae family (such as for example Spodoptera sp., Helicoverpa sp., Trichoplusia sp., Chrysodeixis sp., Autographa sp.) or from the Gelechiidae family (such as for example Tuta sp., Anarsia sp., Phthorimaea sp.), and/or
from the Coleoptera order, more preferably from The Coleoptera order can be selected from Elateridae family (such as for example Agriotes spp., Ludius spp., Ctenicera spp., Selatosomus spp., Chyptohypnus spp., Hypnoidus spp., Limonius spp., Aeolus spp., Hadromorphus spp., Hypnoidus spp., Melanotus spp., Pheletes spp., Conoderus spp., Athous spp., Agrypnus spp., Agrypnus variabilis, Pheletes californicus, Ludius aeripennis tinctus, Ludius aeripennis destructor, Ctenicera destructor, Ctenicera aeripennis destructor, Selatosomus destructor, Selatosomus aeripennis destructor, Selatosomus aeripennis aeripennis, Chyptohypnus nocturnus bicolor, Cryptohypnus nocturnus (Eschscholtz), Hypnoidus nocturnus, Hypolithus bicolor, Limonius californicus, Aeolus mellillus, Agriotes mancus, Hadromorphus glaucus, Agriotes brevis, Agriotes rufipalpis, Agriotes proximus, Agriotes littigiosus, Agriotes criddlei, Agriotes lineatus, Agriotes obscurus, Agriotes sputator, Agriotes, sordidus, Agriotes ustulatus, Hypnoidus abbreviates, Limonius canus, Limonius pctoralis, Limonius infuscatus, Agriotes fuscicollis, Melanotus opacaicicollis leconte), Tenebrionidae family (such as for example Gonocephalum spp., Adelium spp., Pterohelaeus spp., Gonocephalum aequatoriale, G. bilineatum, G. carpentariae (northern false wireworm), G. contractum, G. depressum, G. dorsogranosum, G. elderi (vegetable beetle), G. hoffmannseggii, G. macleaya, G. misellum, G. patruele, G. pusillum, G. reticulatum, G. rusticum, G. seriatum, G. setulosum, G. simplex (dusty surface beetle), G. torridum, G. tuberculatum, G. walker, Adelium brevicorne, Pterohelaeus alternatus) Chrysomelidae family (such as for example Diabrotica spp., Leptinotarsa spp., Phyllotreta spp., Chaetocnema spp.), Scarabidae family (such as for example Phyllophaga spp., Cyclocephala spp., Popilia spp., Halotrichia spp.), Curculionidae family (such as for example Anthonomus spp., Sphenopherus spp., Otiorhynchus spp.), and Nitidulidac family (such as for example Meligethes spp.). The most preferred pest can be from the Diabrotica genus, such as for example Diabrotica balteata, or from the Agriotes genus, such as for example Agriotes lineatus.

The active ingredient composition according to the present invention achieves a high degree of pest control, especially within a very short time such as for example at least three days after application.

In the present invention, further active ingredients may be combined with the component A and/or the component B of the invention and used in the methods of the invention and applied simultaneously or sequentially with the components A and B of the invention. When applied simultaneously, these further active ingredients may be formulated together with the compositions of the invention or mixed in, for example, the spray tank. These further biocidally active ingredients may be fungicides, herbicides, insecticides, bactericides, acaricides, nematicides, plant growth regulators, and/or biologicals.

The following mixtures of the component A and/or of the component B with further active ingredients are preferred: acibenzolar-s-methyl, metalaxyl-M, metalaxyl, picarbutrazox, oxathiapiprolin, ethaboxam, fludioxonil, azoxystrobin, thiabendazole, difenoconazole, tebuconazole, ipconazole, mefentrifluconazole, prothioconazole, triticonazole, sedaxane, inpyrfluxam, penflulen, fluopyram, fluxapyroxad, pydifulmetofen, cylobutrifluram, thiamethoxam, isoflucypyram, chlothianidin, benzovindiflupyr, cymoxanil, phosphite (phosphonate), silthiofam, pyraclostrobin, isotianil, tolprocarb, quinofumelin, ipflufenoquin, metyltetraprole, florylpicoxamid, fenpicoxamid, fluoxytioconazole, fluindapyr, isoflucypram, fluoxapiprolin, broflanilide, imidacloprid, acetamiprid, cyantraniliprole, chlorantraniliprole, tetraniliprole, fluxamethamide, penthiopyrad, mandipropamid, dimpropyridaz, flupyrimin, triflumczopyrim, oxazosulfyl, dichlobentiazox, benzpirimoxan, hymexazol, pyrapropoyne, cyclaniliprole, mandestrobin, copper, lambdha-cyhalothrin, phenamacril, abamectin, tefluthrin, picoxystrobin, spiropidion, oligosaccharins, Melaleuca alternifolia, fosthiazate, fenamifos, oxamyl, fluensulfone, Fluazanindolizine, spirotetramat, spidoxamat, fluazinam, indazapyroxamet, thiophanate methyl, zoxamide, fluoxastrobin, pirimifos, tetrachlorantraniliprole, bifenthrin and emamectin.

The following mixtures of the component A and/or of the component B with further active ingredients are most preferred: acibenzolar-s-methyl, metalaxyl-M, metalaxyl, picarbutrazox, oxathiapiprolin, ethaboxam, fludioxonil, azoxystrobin, thiabendazole, difenoconazole, tebuconazole, ipconazole, mefentrifluconazole, prothioconazole, triticonazole, sedaxane, inpyrfluxam, penflulen, fluopyram, fluxapyroxad, pydifulmetofen, cylobutrifluram, thiamethoxam

In a particular embodiment, the component A and/or the component B can be combined with at least two, three or four, of the further active ingredients as described above.

More particularly, the component A and/or the component B can be combined with at least two of the further active ingredients selected from sedaxane, mefenoxam, difenoconazole, thiametoxam, and fludioxonil; preferably at least three of the further active ingredients selected selected from sedaxane, mefenoxam, difenoconazole, thiametoxam, and fludioxonil; preferably at least four of the further active ingredients selected selected from sedaxane, mefenoxam, difenoconazole, thiametoxam, and fludioxonil; and more preferably with all said further active ingredients selected selected from sedaxane, mefenoxam, difenoconazole, thiametoxam, and fludioxonil. The preferred combination can be a combination of the component A with sedaxane, mefenoxam, difenoconazole and thiametoxam, or a combination of the component A with sedaxane, mefenoxam, difenoconazole and fludioxonil.

When the component A, the component B and at least one of said further active ingredients are combined, or the component A and at least two of said further active ingredients are combined, or the component B and at least two of said further active ingredients are combined, the weight ratio between any two components independently of each other can be from 1:100 to 100:1, preferably 1:50 to 50:1, and even more preferably 1:10 to 10:1. For example, the mixtures can be as follows: component A (7.7 g/L), sedaxane (7.7 g/L), mefenoxam (15.3 g/L), difenoconazole (36.8 g/L), and thiametoxam (61.3 g/L); component A (19.1 g/L), sedaxane (19.1 g/L), mefenoxam (38.4 g/L), difenoconazole (92.2 g/L), and thiametoxam (153.4 g/L); or component A (15.4 g/L), sedaxane (15.4 g/L), mefenoxam (9.2 g/L), difenoconazole (36.9 g/L), and fludioxonil (7.7 g/L).

### EXAMPLES

The following non-limiting examples demonstrate the improved behaviour associated with a pesticidal composition according to the present invention.

A synergistic effect exists whenever the action of an active ingredient combination is greater than the sum of the actions of the individual components.

The action to be expected E for a given active ingredient combination obeys the so-called COLBY formula and can be calculated as follows (COLBY, S. R. “Calculating synergistic and antagonistic responses of herbicide combination”. Weeds, Vol. 15, pages 20-22; 1967):
ppm=milligrams of active ingredient per liter of spray mixture
X=% action by active ingredient A) using p ppm of active ingredient
Y=% action by active ingredient B) using q ppm of active ingredient. According to COLBY, the expected (additive) action of active ingredients A)+B) using p+q ppm of active ingredient is

If the action actually observed (O) is greater than the expected action (E), then the action of the combination is super-additive, i.e. there is a synergistic effect. In mathematical terms the synergism factor SF corresponds to O/E. In the agricultural practice an SF of ≥1.2 indicates significant improvement over the purely complementary addition of activities (expected activity), while an SF of ≤0.9 in the practical application routine signals a loss of activity compared to the expected activity.

The products used in the following examples are detailed below:
VIRANTRA SC400 (commercialized by Syngenta) is an SC400 formulation (suspension concentrate with 400 g of active ingredient per liter) comprising isocycloseram as active ingredient;
FS400 is a flowable concentrate for seed treatment comprising 400 g of active ingredient per liter, comprising isocycloseram as active ingredient;
COSTAR WG 18 (commercialized by Syngenta) is a WG product (water dispersible granules comprising 18% by weight of active ingredient over the total weight of the product) including 90.4 million I.U./g of Bacillus thuringiensis var. kurstaki strain SA-12 (Bt1) as active ingredient; and
NOVODOR FC is a SC product (suspension concentrate comprising 30 g/L of active ingredient) including 10000 I.U./mg of Bacillus thuringiensis var. tenebrionis strain NB-176 (Bt2) as active ingredient.

### DESCRIPTION OF THE EXPERIMENTS

### Example 1 (Spodoptera sp.)

The products VIRANTRA SC400 and COSTAR WG 18 are diluted with the addition of water to obtain the concentrations of active ingredients gathered in Table 1 and Table 2, and were applied on soybean plants (planted in pots; ˜8 plants per pot, 5 pots per treatment), in using a turn table application machine (500 l/ha). After drying 10 soybean plants were cut and placed in a petri dish (diameter: 14.5 cm) containing 3 wet filter papers (4 ml water); 3 replicates per concentration were done. Plants were infested with 10 Spodoptera littoralis larvae (second instar of larvae) and petri dish was covered with a round cotton tissue and closed with a plastic lid. Three and five days after application mortality was assessed.

The results are gathered in the below tables 1 and 2, wherein the table 1 relates to results three days after application (3DAA) and the table 2 relates to results five days after application (5DAA).

TABLE 1

| | | % mortality | |
|---|---|---|---|
| | | (3DAA) | |
| Amount of parts per million (ppm) of | Gram of active | Observed | Expected |
| active ingredient (AI) | ingredients per hectare | Results | Results |
| 0.4 ppm of isocycloseram | 0.2 g AI/ha | 0 | / |
| 45 ppm of Bt1 | 22.5 g AI/ha | 20 | / |
| 0.4 ppm of isocycloseram and 45 ppm | 0.2 g AI/ha + | 53 | 20 |
| of Bt1 | 22.5 g AI/ha | | |

TABLE 2

| | | % mortality | |
|---|---|---|---|
| | | (5DAA) | |
| | Gram of active | Observed | Expected |
| Amount of active ingredient (AI) | ingredients per hectare | Results | Results |
| 0.4 ppm of isocycloseram | 0.2 g AI/ha | 7 | / |
| 45 ppm of Bt1 | 22.5 g AI/ha | 30 | / |
| 0.4 ppm of isocycloseram and 45 ppm | 0.2 g AI/ha + | 57 | 35 |
| of Bt1 | 22.5 g AI/ha | | |

### Example 2 (Diabrotica sp.)

The products FS400 and NOVODOR 3% FC were diluted with the addition of water to have the dose of active ingredient for 30 seeds plus an overage of 10%. These extra 10% were needed to compensate for losses of active ingredient during the seed treatment process. 30 seeds of corn were placed in a spheric glass beaker, and the application solution was added. The beaker was swung to mix the seeds with the solution. After drying, four seeds were sown per pot. 5 replicates per treatment were prepared. 14 days after sowing the pots were infested with 5 second instar larvae of Diabrotica balteata. 6 days after infestation (6DAI) the mortality of larvae and the damage on the plants was assessed.

The results are gathered in the table below wherein the table 3 relates to results of the mortality assessment 6 days after infestation and the table 4 relates to the assessment of plant damage 6 days after infestation (6DAI).

TABLE 3

| | | g of | | |
|---|---|---|---|---|
| | Dose a.i. | active | | |
| | in mg/ | ingredient per | % Mortality (6DAI) | |
| | seed | 100 kg seeds | observed | expected |
| | 0.03 + 0.1 | 10 + 30 | 79 | 58 |
| | 0.01 + 0.03 | 3 + 10 | 54 | 33 |
| Isocycloseram | 0.03 | 10 | 58 | |
| | 0.01 | 3 | 33 | |
| Bt2 | 0.1 | 30 | 0 | |
| | 0.03 | 10 | 0 | |
| Control | 0 | | | |

TABLE 4

| | | g of | | |
|---|---|---|---|---|
| | | active | | |
| | | ingredient | | |
| | Dose | per | % Plant damage reduction | |
| | a.i. in | 100 | (6DAI) | |
| | mg/seed | kg seeds | observed | expected |
| Isocycloseram + | 0.03 + 0.1 | 10 + 30 | 83 | 56 |
| Bt2 | 0.01 + 0.03 | 3 + 10 | 56 | 29 |
| Isocycloseram | 0.03 | 10 | 50 | |
| | 0.01 | 3 | 33 | |
| Bt2 | 0.1 | 30 | 11 | |
| | 0.03 | 10 | −6 | |
| Control | | | 0.0 | |

### Example 3 (Agriotes sp.)

The products FS400 and NOVODOR 3% FC were diluted with the addition of water to have the dose of active ingredient for 30 seeds plusan overage of 10%. These extra 10% were needed to compensate for losses of active ingredient during the seed treatment process. 30 seeds of barley were placed in a spheric glass beaker, and the application solution was added. The beaker was swung to mix the seeds with the solution. After drying two seeds were sown per pot. 10 replicates per treatment were prepared. 5 days after sowing the pots were infested with 10 wireworms (Agriotes lineatus, approx. 20 mm length). 20 days after infestation (20DAI), the corrected mortality of the wireworms was assessed based on the control treatment. 6 days after infestation (6DAI) the plant height was measured.

The results are gathered in the table below wherein the table 5 relates to results of the mortality assessment 20 days after infestation (20DAI) and the table 6 relates to the assessment of plant damage (plant height in cm) 6 days after infestation (6DAI).

TABLE 5

| | Dose | g of | % Corrected mortality (20 | |
|---|---|---|---|---|
| | in μg/ | active/ | DAI) | |
| | seed | 100 kg seed | observed | expected |
| Isocycloseram | 1.25 | 24 | 25 | |
| | 0.25 | 6 | 17 | |
| Isocycloseram + | 1.25 + 5 | 24 + 120 | 30 | 25 |
| Bt2 | 0.25 + 5 | 6 + 120 | 23 | 17 |
| Bt2 | 5 | 120 | 0 | |

TABLE 6

| | | g of | | % Increase plant height in | |
|---|---|---|---|---|---|
| | | active/ | Plant | comparison to infested control | |
| | Dose in | 100 kg | height in | (6DAI) | |
| | μg/seed | seed | cm | observed | expected |
| Control not | | | 14.9 | | |
| infested | | | | | |
| Control | | | 9.3 | | |
| infested | | | | | |
| Isocycloseram | 1.25 | 24 | 10.6 | 14 | |
| | 0.25 | 6 | 10.2 | 10 | |
| Isocycloseram + | 1.25 + 5 | 24 + 120 | 12.2 | 31 | 14 |
| Bt2 | 0.25 + 5 | 6 + 120 | 10.6 | 14 | 10 |
| Bt2 | 5 | 120 | 9 | 0 | |

1. A pesticidal composition comprising a component A and a component B, characterized in that the component A is isocycloseram, and the component B is a component selected from Bacillus species, its fermentation solids, and its insecticidal toxins.

2. A pesticidal composition according to claim 1, characterized in that the component B is Bacillus thuringiensis, and preferably Bacillus thuringiensis var. kurstaki or Bacillus thuringiensis var. tenebrionis.

3. A pesticidal composition according to claim 1, characterized in that the weight ratio of component A to component B can range from 1:1 to 1:10000, preferably from 1:1 to 1:2000, preferably from 1:1 to 1:1000, and more preferably from 1:1 to 1:500.

4. A pesticidal composition according to claim 1, characterized in that the component A is used to prepare a suspension concentrate, a flowable suspension, a suspoemulsion, a suspension concentrate-capsule suspension blend, water soluble granules, water dispersible granules, water dispersible tablets, a dispersible concentrate, or an oil dispersion.

5. A pesticidal composition according to claim 1, characterized in that the component B is used to prepare water dispersible granules or wettable powders.

6. A pesticidal composition according to claim 1, characterized in that it further comprises at least one of the components selected among a polyoxyalkylene copolymer, an acrylic graft copolymer, an oxygenated hydrocarbon, a lignin compound, a lactamide compound, and an ether type solvent

7. A pesticidal composition according to claim 1, characterized in that it further comprises at least a sulfonated compound, preferably a polyorganosulfonate salt, and more preferably sodium poly(naphthaleneformaldehyde) sulfonate.

8. A pesticidal composition according to claim 1, characterized in that it further comprises one or more formulation additives selected among an anti-freeze agent, an anti-foam agent, an anti-bacterial agent (or biocide), a viscosity modifier, a pH modifier, and any mixture thereof.

9. A method of combating and/or controlling an animal pest, which comprises applying to a pest, to a locus of a pest, to a plant susceptible to attack by a pest, or to a plant propagation material susceptible to attack by a pest, a combination of components A and B, characterized in that the components A and B are as defined in claim 1.

10. The method according to claim 9, characterized in that the components A and B are applied in mixing a formulation containing the component A and a formulation containing the component B.

11. The method according to claim 9, characterized in that the method is applied in spraying the pesticidal composition.

12. A method according to claim 9, wherein the components A and B are applied in a sequential manner.

13. The method according to claim 9, characterized in that the pest is from the Lepidoptera order and/or from the Coleoptera order.

14. The method according to claim 9, characterized in that the plant is selected from cereals, leguminous crops, fibre plants, and vegetables.

15. Use of the pesticidal composition according to claim 1, to combat and/or control the pests from the Lepidoptera order and/or from the Coleoptera order.
